(19) United States
(12) Patent Application Publication
(10) Pub. No.: US 2007/0227011 A1
(43) Pub. Date: Oct. 4, 2007

(54) Clipping Device and Methods for Operating Such a Device

(76) Inventor: Drazen Caric, Klagenfurt (AT)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(21) Appl. No.: 11/629,604

(22) PCT Filed: Jun. 10, 2005
(86) PCT No.: PCT/IB05/51913

§ 371 Date: Dec. 13, 2006

(30) Foreign Application Priority Data
Jun. 15, 2004 (EP) 04102707.9

(51) Int. Cl. B26B 11/00

(52) U.S. Cl. 30/123

(57) ABSTRACT

Nicks or injuries due to misuse of a clipping device (1) having a comb unit (4) to be movably mounted on a casing (2) to cover a cutting unit (3) are avoided when the clipping device (1) includes detection means (5) for detecting the position of the comb unit (4) with respect to the cutting unit (3), and warning means (6) for generating warning signals which indicate the detected position. The position is preferably first detected at the instant when the clipping device (1) is switched on and repeatedly after it has been switched on, whilst the warning means generates a warning signal after the first detection and subsequently only when the position has changed.

The invention relates to a clipping device as used for cutting hair, trimming beards or trimming animals, and to methods of operating such a device.

Clipping devices are widely used for cutting hair, especially for short haircuts and around the ears or for trimming beards. Dogs, e.g. poodles or other animals may also be trimmed with a clipping device.

Clipping devices generally have a cutting unit with two blades moving with respect to each other by means of a motor. The cutting device is normally mounted on a casing which houses the motor or batteries as a power supply for the clipping device. To define a certain cutting length, a comb unit is mounted on the casing which covers the cutting unit. The actual cutting length is defined by the fin length of the comb unit. The hair length is equivalent to the distance between the blades and the skin on which the comb unit, mounted on the casing, is applied. To increase the range of use of the clipping device, either different comb units having fins of various lengths or comb units that are movable with respect to the cutting unit are provided to allow haircuts at different lengths.

A hair-cutting device with an adjustable attachment comb is described in U.S. Pat. No. 6,079,103. The adjustable attachment comb includes a stationary comb chassis and a movable comb body. The stationary comb chassis is designed to be removably attached to the hair-cutting device, and the movable comb body is designed to be attached to the stationary comb chassis and positioned at any one of a number of settings, each different setting enabling the combination of hair-cutting device and attachment comb to be used to trim hair to a different uniform length. To indicate a specific setting to the user, an indicator window is cut into the movable comb body. The indicator window may show the length the hair will be cut to, or a number or symbol assigned to a set of single length attachment combs, in which the number or symbol designates which one of the single length attachment combs the current adjustable attachment comb is equivalent to at this particular setting. The numbers or symbols that show through the indicator window should be marked on the substantially planar top surface of the stationary comb chassis.

It is a fact that even professional users of such devices do not always pay attention to the number or symbol in the indicator window and inadvertently use a clipping device with the wrong comb unit position or no comb unit mounted at all. This may particularly occur when the users are interrupted during the cutting process or are trying to cut their own hair or beards, which may not only lead to miscuts, but even to injuries, if the clipping device is inadvertently used without a comb unit. A further impediment to inexperienced, non-professional users is that they may not quite understand the meaning of the numbers or symbols.

It is an object of the invention to provide a clipping device ensuring safe use, i.e. minimizing the risk of misuse, as well as methods of operating such a clipping device.

In a first aspect, the invention provides a clipping device comprising a casing, a cutting unit connected with the casing, a comb unit to be mounted on the casing and/or the cutting unit, detection means for detecting whether the comb unit is mounted and warning means for generating a warning signal indicating that the comb unit is not mounted.

In a second aspect, the invention provides a clipping device comprising a casing, a cutting unit connected with the casing, a comb unit to be mounted movably on the casing and/or the cutting unit, detection means for detecting the position of the comb unit with respect to the cutting unit and/or the casing, and warning means for generating warning signals indicating the position detected by said detection means.

The warning means is preferably arranged to generate optical and /or acoustic and/or tactile signals.

In preferred embodiments of the invention, the detection means is arranged to detect the position or the presence of the comb unit at the instant when the clipping device is switched on and repeatedly after it has been switched on. The warning means is arranged to generate a signal indicating the first detected position or a change of position, including the case in which the comb unit is not mounted.

In further aspects, the invention provides methods of operating a clipping device according to the invention, the methods comprising the steps of detecting the position of the comb unit with respect to the cutting unit and generating a warning signal indicating the detected position, including the case in which the comb unit is not mounted. The position may be detected when the clipping device is switched on and/or may be repeatedly detected during use of the clipping device. Accordingly, the warning signal may be generated when the first position is detected, when the comb unit is not mounted or when the detection result has changed.

A preferred embodiment of the invention will be described hereinafter with reference to the drawings in which:

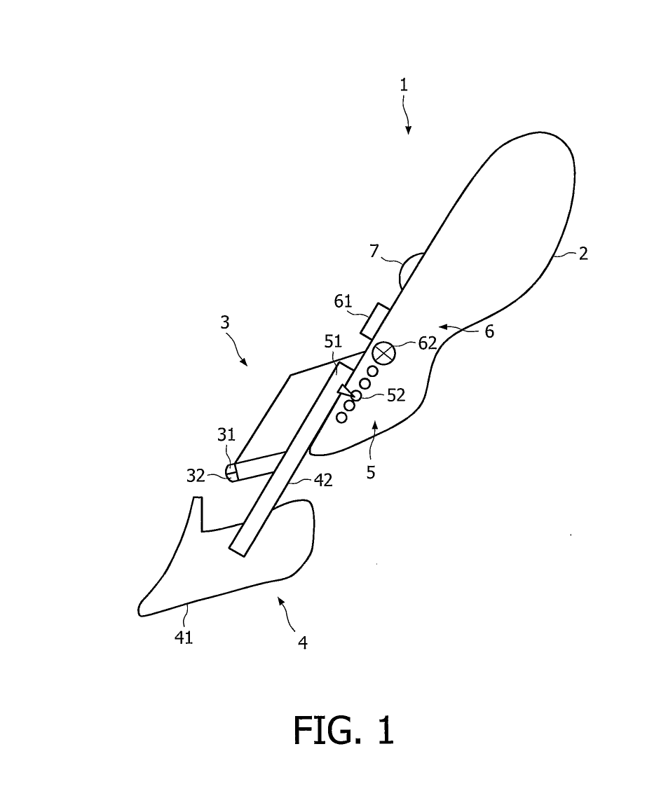

FIG. 1 shows an embodiment of the clipping device according to the invention, with a comb unit mounted;

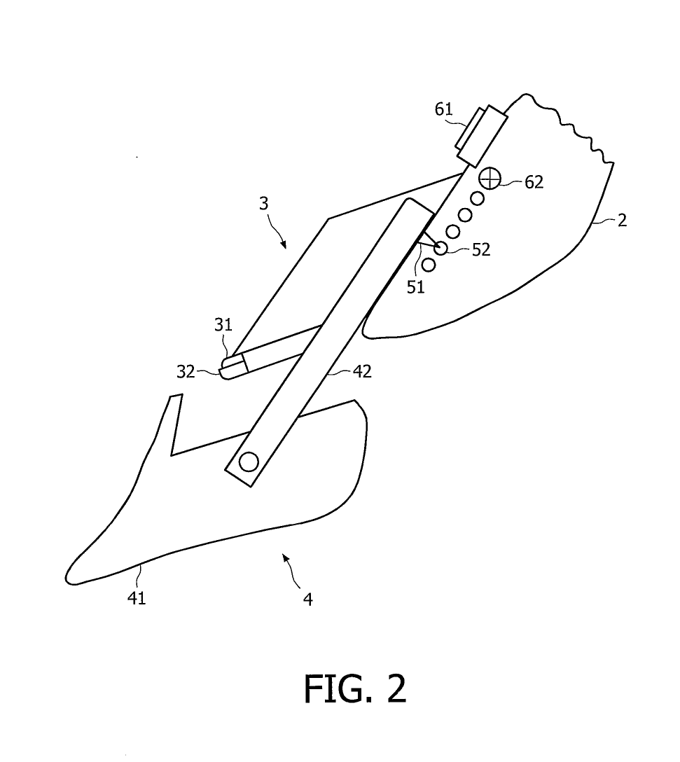

FIG. 2 shows an enlarged part of the clipping device of FIG. 1;

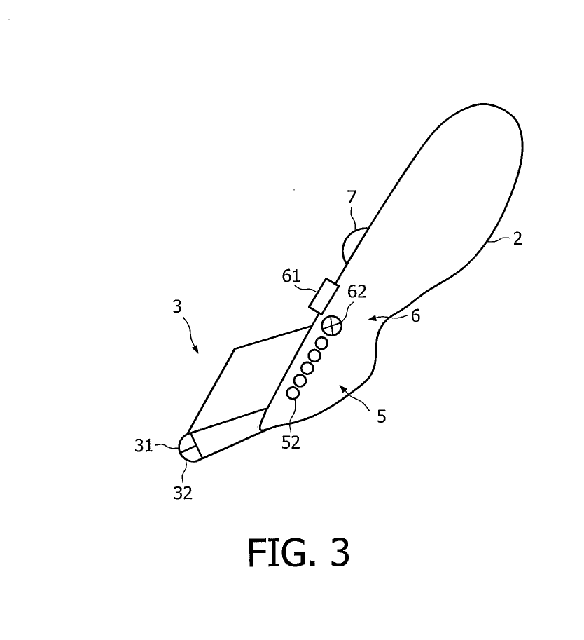

FIG. 3 shows the clipping device of FIG. 1 with a removed comb unit.

FIG. 1 shows a clipping device 1 including a casing 2, a cutting unit 3, a comb unit 4, detection means 5 and warning means 6. The cutting unit 3 with blades 31, 32 is fixed on the casing 2. The casing houses a motor for driving the cutting unit 3 and an adapter for connecting the clipping device 1 with an external power supply. Instead of an adapter, the casing 2 may house one or more batteries as an internal power supply, or both an adapter and batteries. The clipping device 1 is switched on and off by means of the switch 7.

The blades 31, 32 of the cutting unit 3 are moved with respect to each other in a direction perpendicular to the plane of the drawing for cutting all sorts of hair. It will be evident that other cutting units may be used in other preferred embodiments of the invention, such as e.g. cutting units with different types of blades or only one blade. The length of the cut hair is defined by the comb unit 4 which is mounted on the casing 2 and shields the blades 31, 32. The comb unit 4 includes a comb body 41 with fins (not visible in this perspective view) causing the hair to stand upright for cutting when combed. The comb body 41 is connected with the casing 2 via the comb fixation 42. The comb unit 4 of the present example can be set to five different positions in accordance with the placement of the five sensors 52 for defining different lengths of haircuts.

The five sensors 52 are used to detect any possible position of the comb unit 4. However, only one sensor is actually necessary for the invention to work. This one sensor can e.g. detect whether the comb unit is mounted or not, or it can detect one very sensitive position of a mounted comb unit. The latter case could be useful for clipping devices having a security switch to ensure that the clipping device cannot be switched on without any comb unit mounted on the casing and shielding the blades of the cutting unit.

It will be obvious to the person skilled in the art that a clipping device with a non-movable comb unit is similar to the clipping device 1 shown in FIG. 1. It can also work with one or more sensors as detection means. Furthermore, several sensors may be used with a set of different comb units having different fin lengths and being mountable on the casing, and/or with the cutting unit having different fixation points corresponding to different, respective sensors.

In accordance with the present example, the position of the comb unit 4 with respect to the cutting unit 3 is detected by detection means shown in more detail in FIG. 2. In this example, the detection means includes an indicator 51 fixed on the comb fixation 51 and touching different sensors 52, designed as contact switches, depending on the position of the comb unit 4 with respect to the cutting unit 3. It will be evident to the person skilled in the art that any other kind of sensor may be used, such as optical sensors, magnetic sensors or other sensors in combination with any appropriate type of indicator.

If a sensor 52 is activated by the indicator 51, indicating a certain position of the comb unit 4, or if no sensor 52 is activated, indicating that the comb unit 4 is not mounted, then the warning means including e.g. a speaker 61 or a lamp 62 generates a warning signal like a tone or a sequence of tones or a light. In the present example, various types of signals are combined. If no comb unit is mounted, as is schematically shown in FIG. 3, the speaker 7 generates a steady tone lasting several seconds whilst the lamp 62 blinks so as to draw the user's attention to the fact that the comb unit is missing. The sensors 52 are combined with light-emitting diodes in different colors ranging from deep red for the position equivalent to the shortest haircut, to green for the position equivalent to the longest haircut, the range of colors passing via e.g. shades of orange and yellow, and emitting a warning signal when the respective sensor is activated. Simultaneously, the speaker 7 generates warning tones such as three short pulses for a very short length, two pulses for a fairly short length and one pulse for an intermediate length. Of course, many other warning signals and combinations may be used, for example, tactile warning signals like an intensive vibration of the device.

An important aspect of this invention is to make the “user—clipping device” interface more secure to avoid misuse of the device. This is achieved by not only providing indicating means giving information on the comb unit's position, as in the prior art, but also by providing warning signals that will be noticed during cutting and even when the user is not concentrated on the cutting process or when he has not checked the clipping device beforehand. By drawing the user's attention to the position or absence of the comb unit, it is ensured that, for example, nicks or other skin injuries caused by the blades are avoided.

To achieve this, it has proved most helpful to check the position or the presence of the comb unit 4 at the instant when the clipping device 1 is switched on and to give an appropriate warning signal, i.e. indicating the absence of a comb unit or its actual position on the casing. For even more security, there should not only be one punctual check, but repeated checks during use of the clipping device 1, so that the detection means 5 checks repeatedly, in regular or random time intervals, whether the comb unit 4 is still mounted on the casing 2 and/or the cutting device 3 and, if so, in what position, in case appropriate sensors are provided. In preferred embodiments of the invention, the position or the presence of the comb unit 4 is checked by the detection means at switch-on and then repeatedly after switch-on.

Depending on the detection result, a warning signal is generated by the warning means 6. The detection means 5 and the warning means 6 may be connected by means of a commonly known signal-generating logic control circuit. Such electric circuits are available as integrated circuits and can easily be incorporated into the casing 2. The warning means 6 preferably generates signals indicating the absence of the comb unit 4 or drawing attention to particular comb unit positions, particularly to positions leading to a short haircut.

Whilst various preferred embodiments of the invention have been shown and described, it will be evident that those skilled in the art are able to conceive other modifications, substitutions and alternatives without departing from the spirit and scope of the invention.

### LIST OF REFERENCE NUMERALS

1 clipping device
2 casing
3 cutting unit
31 blade
32 blade
4 comb unit
41 comb body
42 comb fixation
5 detection means
51 indicator
52 sensor
6 warning means
61 speaker
62 light
7 switch

1. A clipping device comprising:
a casings,
a cutting unit connected to the casings,
a comb unit to be mounted on the casing and/or the cutting unit,
detection means detecting whether the comb unit (4) is mounted on the casing and/or the cutting unit,
warning means for generating a warning signal which indicates that the comb unit is not mounted.

2. A clipping device comprising:
a casing,
a cutting unit connected to the casing,
a comb unit to be movably mounted on the casing and/or the cutting unit,
detection means detecting the position of the comb unit with respect to the cutting unit and/or the casing,
warning means for generating warning signals which indicate the position detected by said detection means.

3. The clipping device of claim 1, wherein the warning means (6) is arranged to generate optical and/or acoustic and/or tactile signals.

4. The clipping device of claim 1, wherein the detection means is arranged to detect the position or the presence of the comb unit at the instant when the clipping device is switched on.

5. The clipping device of claim 1, wherein the detection means is arranged to detect the position or the presence of the comb unit repeatedly after the clipping device has been switched on, and wherein the warning means is arranged to generate a warning signal only when the detection result has changed as compared to the previous detection.

6. The clipping device of claim 1, wherein the detection means is arranged to detect the position or the presence of the comb unit at the instant when the clipping device is switched on and repeatedly after it has been switched on, and wherein the warning means is arranged to generate a warning signal only when it is the first detection after the clipping device has been switched on and the comb unit is mounted on the casing, or when the comb unit is not mounted, or when the position has changed as compared to the previous detection.

7. A method of operating a clipping device as claimed in claim 1, the method comprising the steps of
detecting the position of the comb unit with respect to the cutting unit, or detecting the presence of the comb unit, and
generating a warning signal indicating the detected position, or indicating that the comb unit is not mounted on the casing.

8. A method of operating a clipping device as claimed in claim 1, the method comprising the steps of
detecting the position of the comb unit with respect to the cutting unit, or detecting the presence of the comb unit at the instant when the clipping device is switched on, and
generating a warning signal indicating the detected position, or indicating that the comb unit is not mounted on the casing.

9. A method of operating a clipping device as claimed in claim 1, the method comprising the steps of
detecting the position of the comb unit with respect to the cutting unit, or detecting the presence of the comb unit repeatedly,
comparing the detection result with the previously detected result, and
generating a warning signal when the position has changed or when the comb unit is not mounted on the casing.

10. The method of claim 9, comprising the further step of first detecting the position or the presence of the comb unit at the instant when the clipping device is switched on and generating a warning signal indicating said first detected position or indicating that the comb unit is not mounted on the casing and/or cutting unit.
